(19) United States
(12) Patent Application Publication
(10) Pub. No.: US 2016/0035019 A1
(43) Pub. Date: Feb. 4, 2016

(54) Electronic Marketplace Platform for Expiring Inventory

(71) Applicant: Stayful.com, Inc., San Francisco, CA (US)

(72) Inventors: Cheryl Rosner, San Francisco, CA (US); Shariq Minhas, San Mateo, CA (US)

(21) Appl. No.: 14/817,568

(22) Filed: Aug. 4, 2015

Related U.S. Application Data
(60) Provisional application No. 62/032,793, filed on Aug. 4, 2014.

(51) Int. Cl. G06Q 30/08; G06Q 30/06

(52) U.S. Cl. CPC G06Q 30/08; G06Q 30/0613

(57) ABSTRACT

It is desirable to provide an e-commerce marketplace platform that can create a more responsive and more engaging user experience. Accordingly, the present disclosure introduces a technique to provide an e-commerce marketplace platform that can create a more responsive and more engaging user experience. In some embodiments, the marketplace platform can provide a real-time bidding service for the customers to purchase merchandise, which can be particularly advantageous when applied to the sales of expiring or perishable goods or services.

### RELATED APPLICATION AND PRIORITY CLAIM

This application claims the benefit of and the right of priority to U.S. Provisional Patent Application No. 62/032,793, entitled “ELECTRONIC MARKETPLACE PLATFORM FOR EXPIRING INVENTORY” (Attorney Docket No. 113769-8001.US00), filed Aug. 4, 2014, which is hereby incorporated by reference in its entirety. This application is therefore entitled to an effective filing date of Aug. 4, 2014.

### BACKGROUND

With the ever increasing pervasiveness of modern computer networks (e.g., that provides access to the Internet), personal computing devices have become a ubiquitous tool for conducting commerce. Indeed, electronic commerce (“e-commerce”) allows easy access for a customer user to browse, compare, and purchase different products or services offered from multiple merchants at a time and a location of the user's own preference. As a practical example, the rise of e-commerce has brought significant change to the travel agency industry, where itinerary planning, as well as lodging and transportation arrangements, are all being automated for higher efficiency and better convenience.

However, even being enhanced with computer automation techniques, traditional e-commerce platforms that are provided to customers for conducting travel planning (e.g., hotel booking) lack responsiveness to customers' price demands and do not offer natural yet effective methods to realistically conduct a negotiation process, a process that a customer would be likely to engage with a merchant, and especially one with expiring inventories, if the transaction were to take place face-to-face.

### BRIEF DESCRIPTION OF THE DRAWINGS

The present embodiments are illustrated by way of example and are not intended to be limited by the figures of the accompanying drawings. Like reference numerals refer to corresponding parts throughout the figures and specification.

FIG. 1 illustrates a general environment within which the embodiments of the electronic marketplace platform for expiring inventory may be implemented.

FIG. 2 illustrates an example block diagram of a host server of FIG. 1 as well as other components that together implement the methods introduced here to provide an electronic marketplace platform described herein.

FIG. 3 illustrates an example flow chart of a process that can be implemented by the host server of FIG. 1 for bidding a merchandise item with a contracted merchant (e.g., an “instant hotel”).

FIG. 4 illustrates an example flow chart of a process that can be implemented by the host server of FIG. 1 for bidding a merchandise item with a non-contracted merchant (e.g., an “offline hotel”).

FIG. 5 illustrates an example flow chart of a method for determining the recommended bid in the process of FIG. 3.

FIG. 6 illustrates an example flow chart of a method for determining the recommended bid in the process of FIG. 4.

FIG. 7 illustrates a diagrammatic representation of a machine in the example form of a computer system within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatuses, methods and their related results according to the embodiments of the present disclosure are given below. Note that titles or subtitles may be used in the examples for convenience to the reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

### Electronic Marketplace Platform for Expiring Inventory

As previously mentioned, it is recognized in the present disclosure that traditional e-commerce platforms created to provide travel planning (e.g., hotel booking) lack responsiveness to customers' price demands because they merely offer a platform that provides conventional price quoting functionalities. They also do not offer natural yet effective methods to realistically conduct a negotiation process, a process that a customer would be likely to engage with a merchant if the transaction were to take place face-to-face. This is especially true when the transaction relates to the sales of expiring inventories. Consequently, it is desirable to provide an e-commerce marketplace platform that can create a more responsive and more engaging user experience.

Accordingly, the present disclosure introduces a technique to provide an e-commerce marketplace platform that can create a more responsive and more engaging user experience. In some embodiments, the marketplace platform can provide a real-time bidding service for the customers to purchase merchandise, which can be particularly advantageous when applied to the sales of expiring or perishable goods or services.

In the following description, the example of booking rooms at hotels is used, for illustrative purposes only, to explain various aspects of the technique. Note, however, that the technique introduced here is not limited in applicability to hotels or to any other particular kind of business. As will be discussed in more detail below, in the context of booking rooms at hotels, the disclosed technique offers travelers a way to quickly and easily negotiate the right prices for themselves and their budget, while also creating a unique travel experience to fit their tastes. Additionally, by enabling hotel merchants to fill their unsold inventory at fair booking rates, the technique introduced here can provide the hotels (and especially independent boutique hotels that are not equipped with national sales networks and/or resources) a more efficient mechanism to reduce their expiring inventories over what traditional online booking services provide.

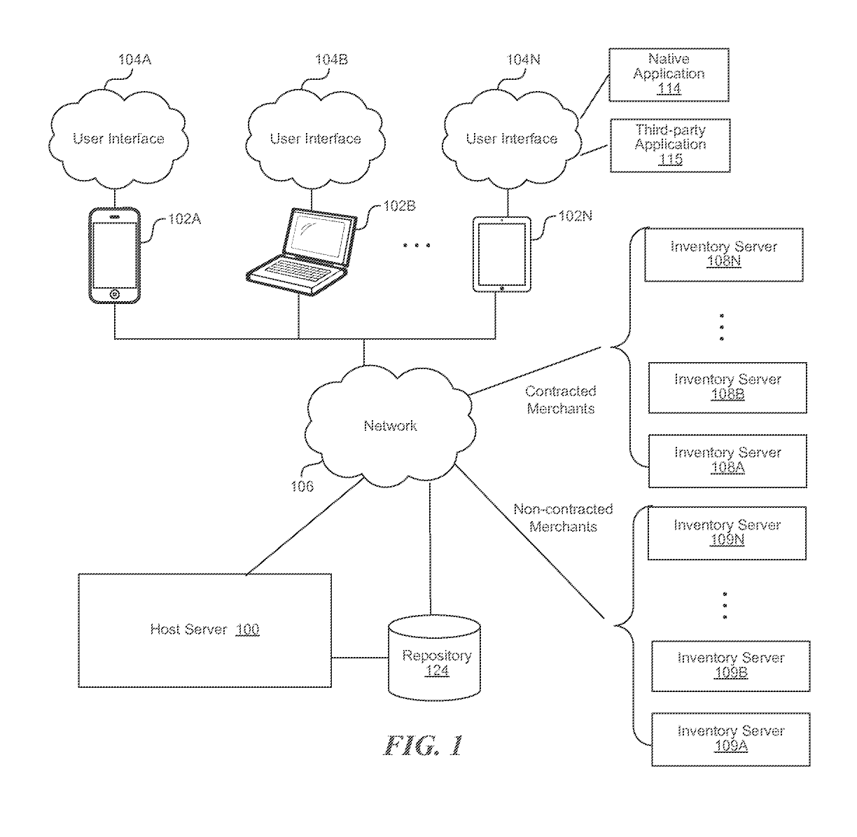

FIG. 1 illustrates a general environment within which the embodiments of the electronic marketplace platform for expiring inventory may be implemented. The environment includes a host server 100 that operates an electronic marketplace platform, allowing multiple ways of providing responsiveness to customers' price demands and offering natural and effective methods to conduct negotiation processes. Among other functions, the platform is able to analyze data and derive fair market price for hotel rooms based on intelligence in a network 106 or across networks including (structured or unstructured) data to or from various online data sources. The online data sources can include servers and databases, including hotel booking services (e.g., hosted by inventory servers 108A-N (from contracted merchants) and 109A-N (from non-contracted merchants)). In some embodiments, the host server 100 is implemented using a cloud-based server service.

The electronic marketplace platform can be accessed through a variety of methods. For example, in some embodiments, the electronic marketplace platform can actively or reactively provide processed data streams (or intelligence) to the users via client devices 102A-N. The client devices 102A-N can be any system and/or device, and/or any combination of devices/systems that are able to establish a connection with another device, a server and/or other systems. Client devices 102A-N each typically include a display and/or other output functionalities to present information and data exchanged between among the devices 102A-N and the host server 100. The client devices 102A-N can be provided with user interfaces 104A-N for accessing the intelligence processed by the platform. The intelligence can be viewed in, for example, a native software application 114 (e.g., a mobile app or a conventional desktop software application) that runs on the client devices 102A-N. In variation, the intelligence can be provided by the platform (e.g., from the host server 100) to third-party applications 115 (e.g., through the use of an application programming interface (API). In some examples, the electronic marketplace platform can be accessed through a software widget that customers can install (e.g., on their user devices 102A-N) so that the customers can browse around merchant's websites (e.g., boutique hotels' websites) and, if the customers see an interested hotel, the customers can launch the widget and access the marketplace platform.

Examples of the client devices 102A-N can include computing devices such as mobile or portable devices or non-portable devices. Non-portable devices can include a desktop computer, a computer server or cluster. Portable devices can including a laptop computer, a mobile phone, a smart phone, a personal digital assistant (PDA), a handheld tablet computer, or a combination thereof. Typical input mechanism on client devices 102A-N can include a touch screen display (including a single-touch (e.g., resistive) type or a multi-touch (e.g., capacitive) type), gesture control sensors, a physical keypad, a mouse, motion detectors (e.g., including 1-axis, 2-axis, 3-axis accelerometer, etc.), light sensors, temperature sensor, proximity sensor, device orientation detector (e.g., electronic compass, gyroscope, or GPS), and so forth.

In forming and maintaining the electronic marketplace platform, the host server 100 may be communicatively coupled to one or more repositories 124 that store raw or processed data. The repository 124 may be physically connected to the host server 100 or can be remotely accessible through the network 106. More specifically, the host server 100 may include internally or be externally coupled to the repository 124. The repository 124 (which may be comprised of several repositories) can store software, descriptive data, images, system information, drivers, and/or any other data item utilized by other components of the host server 100 and/or any other servers for operation. The repositories may be managed by a database management system (DBMS), for example but not limited to, MySQL, PostgreSQL, Microsoft Access, SQL Server, FileMaker, Oracle, RDBMS, dBASE, Clipper, FoxPro, and so forth. In some variations, the repository 124 can be implemented via object-oriented technology and/or via text files, and can be managed by a distributed database management system, an object-oriented database management system (OODBMS), an object-relational database management system (ORDBMS), a file system, and/or any other suitable database management package.

The client devices 102A-N, inventory servers 108A-N and 109A-N, the repository 124, and the host server 100, can be communicatively coupled to each other through the network 106 and/or multiple networks. In some embodiments, the devices 102A-N, the host server 100, and the inventory servers 108A-N and 109A-N may be directly connected to one another. The hotel room booking services hosted by the inventory servers 108A-N and 109A-N can include any suitable online or web-based services or networking services where hotel merchants can post or share their hotel information, including promotional information, onto the network 106. It is typical that these pieces of shared information can be obtained or gathered by the host server 100 using a web crawler.

The network 106 can be any collection of distinct networks operating wholly or partially in conjunction to provide connectivity to the client devices 102A-N, the host server 100, and other suitable components in FIG. 1, which may appear as one or more networks to the serviced systems and devices. In one embodiment, communications to and from the client devices 102A-N can be achieved by an open network, such as the Internet, or a private network, such as an intranet and/or the extranet. For example, the Internet can provide file transfer, remote log in, email, news, RSS, cloud-based services, instant messaging, visual voicemail, push mail, VoIP, and other services through any known or convenient protocol, such as, but is not limited to, the TCP/IP protocol, Open System Interconnection (OSI) protocols, and so forth. In one embodiment, communications can be achieved by a secure communications protocol, such as secure sockets layer (SSL), or transport layer security (TLS).

In addition, communications can be achieved via one or more wired or wireless networks including, for example, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN). These networks can be enabled with communications technologies such as Global System for Mobile Communications (GSM), Personal Communications Service (PCS), Digital Advanced Mobile Phone Service (D-Amps), Bluetooth, Wi-Fi, 2G, 3G, IMT-Advanced, LTE Advanced, mobile WiMax, enhanced data rates for GSM evolution (EDGE), General packet radio service (GPRS), and with messaging protocols such as Ethernet, SMS, MMS, presence protocol (XMPP), real time messaging protocol (RTMP), instant messaging and presence protocol (IMPP), IRC, or any other suitable data networks or messaging protocols.

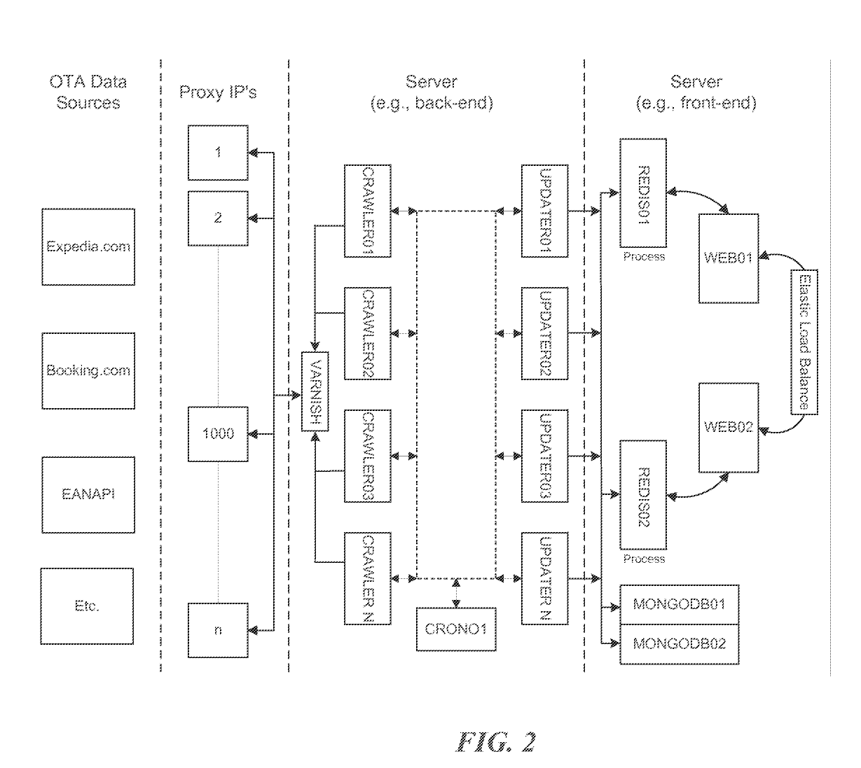

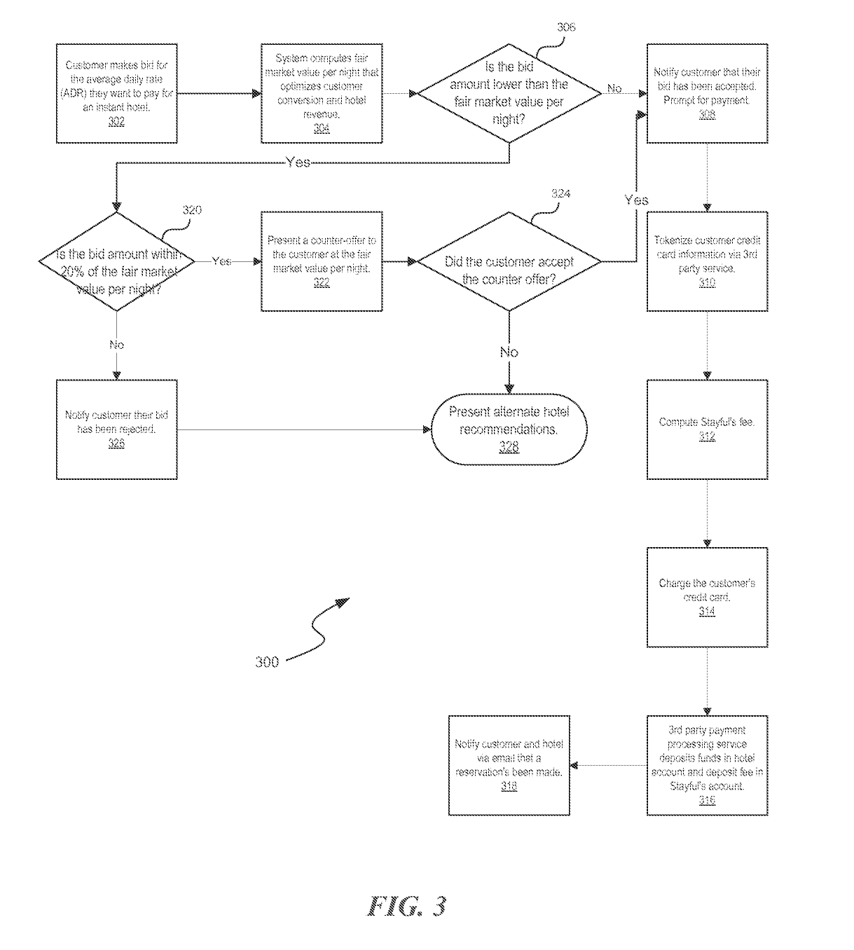

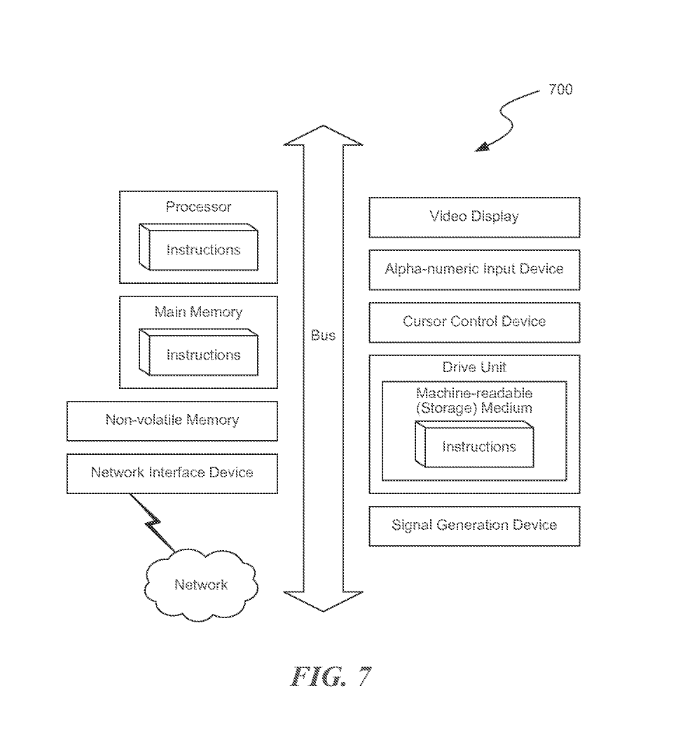

As is discussed in more detail below, with the exemplary components introduced in FIGS. 2 and 7, and the methods introduced in FIGS. 3-6, the electronic marketplace platform that the host server 100 operates is able to offers traveler users a way to quickly and easily negotiate the right prices for themselves and their budget, while also creating a unique travel experience to fit their tastes. Additionally, the electronic marketplace platform is able to enable hotel merchants to fill their unsold inventory at fair booking rates.

### Exemplary Architecture

FIG. 2 illustrates an example block diagram of the host server 100 of FIG. 1 as well as other components that together implement the methods introduced here to provide an electronic marketplace platform described herein. As illustrated in FIG. 2, the host server 100 can be logically and/or physically divided into a front-end portion and a back-end portion. Note that this front-end-back-end dichotomy is used herein for simplicity only; in variations, the host server 100 may have any suitable number or segments implementing any combination of the functionalities introduced here.

The front-end portion of the host server 100 is responsible for generating user interfaces 104A-N, and for receiving customer (or traveler) users' search criteria (e.g., desired travel dates, destination, and hotel categories (such as how many stars)) and their price offering (or bids). The front-end portion of the host server 100 is also responsible for acting as a communication channel between the customer users and the hotel merchants, including tasks such as generating real-time responses (e.g., counter-offers, rejections, or acceptances) to the bids received from the customer users for those contracted hotels (or “instant hotels”), or communicating back and forth between the customer users and hotel merchants for those non-contracted hotels (or “offline hotels”). In some implementations, the host server 100 includes load balancing mechanisms, which may be elastic load balancing such as typically implemented in cloud-based servers.

The back-end portion of the host server 100 is responsible for actively gathering or passively receiving hotel intelligence information (e.g., using web crawlers) from inventory servers 108A-N and 109A-N. In some embodiments, the web crawlers can utilize a number of proxy IPs to connect to the desired data sources (e.g., inventory servers 109A-N). The intelligence information can include, for example, room availability and type, acceptable price ranges for the merchants, recent sales prices, and/or other promotional content or sales instructions/limitations. Particularly, for the contracted hotel merchants, in order to facilitate the price bidding and negotiation process (discussed in more detail below), these hotel merchants can place the suitable information on their corresponding inventory servers 108A-N in order to stimulate the sales of their rooms, and especially for those that are not yet booked within the next 30 days (which is referred to here as “expiring inventory”). For the non-contracted hotel merchants, the back-end portion of the host server 100 can gather information and normalize the data so as to convert them into a common format, suitable for further processing. For example, the number of available rooms, room types, dates, and asking prices can be normalized using the same scale (e.g., for room types), time zone (e.g., for dates), and currency (e.g., for prices). Besides intelligence gathering, and processing, the back-end portion of the host server 100 maintains the repository 124 by updating it with the latest information. In some implementations, the back-end portion of the host server 100 can also gather information indirectly from a third-party broker or agency website other that the one directly hosted by the hotel merchants. Examples of these third-party broker websites include Expedia.com™ and Booking.com™.

In addition, the back-end portion of the host server 100 can perform statistics gathering and data analytics functionalities in order to, for example, calculate the fair market price, or provide hotel merchants relevant sales data so as to enable the merchants to make educated decisions whether or not to accept, refuse, or counter a bid offer from the customer. This also provides educational value to the hotel merchants so that their asking price/price range for their rooms in the future may be more reflective of the market's demand. Among others, these functionalities promotes the electronic marketplace platform introduced here.

More details on exemplary bidding processes that the marketplace platform can provide to the customer users (e.g., through the front-end of the host server 100), and exemplary methods for the marketplace platform to determine recommended bid prices, both for contracted (“instant hotel”) and non-contracted (“offline hotel”) merchants, are provided below.

### Methodology

FIG. 3 illustrates an example flow chart of a process 300 that can be implemented by the host server of FIG. 1 for bidding a merchandise item with a contracted merchant (e.g., an “instant hotel”). Note that, while the methods introduced here (e.g., processes 300, 400, 500, and 600, along with FIGS. 3, 4, 5, and 6) include a number of operations that are discussed and/or depicted as performed in a specific order, these methods may include more or fewer operations, which can be performed in serial or in parallel. An order of two or more operations may be changed, performance of two or more operations may overlap, and two or more operations may be combined into a single operation.

As described above, in one or more embodiments, the hotel merchants are categorized into contracted and non-contracted ones. For contracted merchants, the electronic marketplace platform can determine a fair market value for their inventories (e.g., expiring inventories that will expiring within 30 days) based on a plurality of factors (described below), and can determine whether to accept, refuse, or counter the bids from the customers based on acceptable price ranges that are provided by the contracted merchants (e.g., before the customers start to use the platform to place bids for those rooms). Conversely, for non-contracted merchants, the electronic marketplace platform can only recommend but cannot act as an agent to make decisions for the non-contracted merchants. It is noted that effectiveness of some of the aforementioned advantages (e.g., responsiveness) provided by the electronic marketplace platform may be reduced when a merchant is a non-contracted merchant.

When the customer user desires to use the electronic marketplace platform to book a hotel, the host server 100 first prompts the customer user to enter information about the customer's travel and his or her preferences. As said, such information can include travel dates, destination, bid range, or optionally, number of occupants. With the entered information, the host server 100 generates a list of available hotels, including contracted ones and non-contracted ones. With a few exceptions (e.g., such as when a posted online booking rate for a hotel room is lower than its fair market rate, discussed below), for each listing the host server 100 generates and displays (e.g., via the user interface 104A-N) (1) a recommended bid price and a “Bid Now” button for the customer to enter a bidding offer, and (2) a best online price and a “Book Now” button for the customer to book the hotel directly. The process of generating the recommended bid price is discussed below. The best online price is the lowest available rate for purchasing the hotel room (i.e., without any negotiation or bidding) based on information gathered by the host server 100 (e.g., via the web crawlers).

Now, assume that the customer has already chosen a hotel in which the customer is interested, and that the customer has already seen a recommended bid from the host server 100 as well as the lowest available rate for that hotel in the marketplace at the time the customer performs the search. Further, assume that the customer wishes to engage in a negotiating process on an instant hotel (i.e., from a contracted hotel merchant) by entering a bidding offer. In accordance with some embodiments, when a customer makes a bid for an instant hotel, the host server 100 performs the process 300 to facilitate the bidding. Overall, when the customer makes a bid, the host server 100 can compute the fair market value per night for that hotel room so as to optimize both for the customer's conversion rate (i.e., the probability of succeeding at the bidding) and for the hotel's revenue.

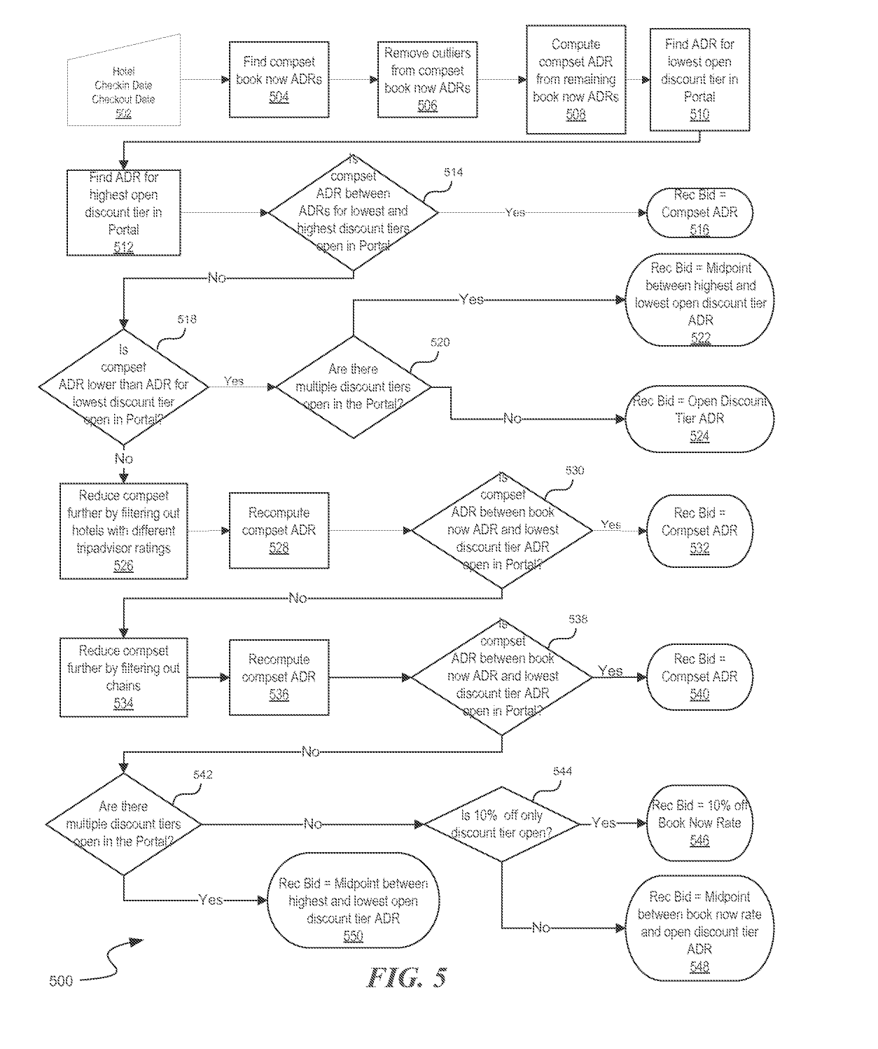

More specifically, when the customer makes (302) a bid for what the customer wants to pay for an instant hotel, the host server 100 calculates (304) a fair market value per night for the hotel that the customer is bidding on. Exemplary calculation and determination processes for Step 304 are discussed in more detail below with respect to FIG. 5. Thereafter, the host server 100 compares (306) the bid amount and the fair market value amount, and determines (306) whether the bid amount that the customer has entered is lower than the fair market value per night (e.g., the recommended bid amount). If the bid amount is not lower than the fair market value per night for the hotel room, then the host server 100 notifies (308) the customer that the bid has been accepted, and the host server 100 prompts (308) the customer for payment.

In some embodiments, the host server 100 tokenizes (310) the customer credit card information (e.g., after receiving it from Step 308) via a third-party service (e.g., encryption and/or validation services). Optionally, the host server 100 can compute (312) a suitable fee for providing its services, and the host server 100 can connect to one or more payment processing service providers (e.g., via the network 106) to charge (314) the customer's credit card. Then, in some embodiments, the third-party payment processing service provider deposits (316) funds into the hotel merchant's financial account (and deposits suitable fee in a financial account of the provider of the host server 100). Thereafter, the host server 100 notifies (318) the customer and the hotel (e.g., via email) that a reservation has been made.

As mentioned above, the instant hotels are the hotel merchants that have contractually agreed to accept a rate range on which the host server 100's determination of whether to accept the consumer's bid offer is based. In some embodiments, this determination based both upon the rate range and the fair market value (e.g., the bid is both at or above the fair market value and within the acceptable rate range).

On the other hand, if the bid amount is lower than the fair market value per night for the hotel room and/or is not within the acceptable rate range (provided by the hotel merchant), then the host server 100 determines (320) whether the bid amount is within a predetermined percentage (e.g., 20%) of the fair market value per night. If the bid amount is within the predetermined percentage of the fair market value per night for the hotel, then the host server 100 generates a counter offer (e.g., using the computed fair market value per night for the hotel) and presents (322) the counter offer (e.g., via the user interface 104) to the customer.

Next, the host server 100 receives (324) a decision from the customer whether the customer accepts the counter offer. If the customer accepts the counter offer, then the host server 100 notifies (308) the customer that the transaction has been accepted and the host server 100 proceeds with the payment steps 310-318. If, however, the customer does not accept the counter offer, then the host server 100 presents (328) alternative hotel recommendations based on those criteria previously entered by the customer.

Referring back to Step 320, if the bid amount entered from the customer is not within the predetermined percentage (e.g., 20%) of the fair market value per night for the hotel, then the host server 100 notifies (326) the customer that the bid has been rejected, and the host server 100 proceeds to Step 328 for alternative hotel recommendations.

In some embodiments, the host server 100 can track all the statistics, and can transmit the analytics of historic data to the hotel merchants so the merchants can determine whether their listing prices are attracting a desirable amount of bids from the customers and/or whether their acceptable price ranges are generating a desirable amount of acceptances.

Additionally, some embodiments of the host server 100 may employ a model that does not require customers to log in or input any of identification information thereof, so that it increases the convenience factor. However, note that, in these embodiments, a limit may be placed on, for example, how many connections or bids can be received from one IP address in order to protect the electronic marketplace platform from being too easily exploited. As one example rule which the host server 100 may enforce, an individual can only place one bid per hotel per day up to three hotels in a market for a specific set of dates. So, for example, if the customer wants to bid for July 4^{th} out to 6^{th} for San Francisco, then with that set of dates, the customer can bid on three hotels. It is noted that the electronic marketplace platform facilitates the sales of perishable inventory, and by enforcing these rules, the host server 100 can prevent one (e.g., a malicious client or a competitor merchant) from bidding over and over again, trying to drive down the rates of the hotels.

In this way, the electronic marketplace platform implemented by the host server 100 simulates a verbal negotiation process that a customer would be likely to engage with a merchant if the transaction were to take place face-to-face. The electronic marketplace platform also enjoys from increased responsiveness to customers' price demands as compared to traditional e-commerce platforms.

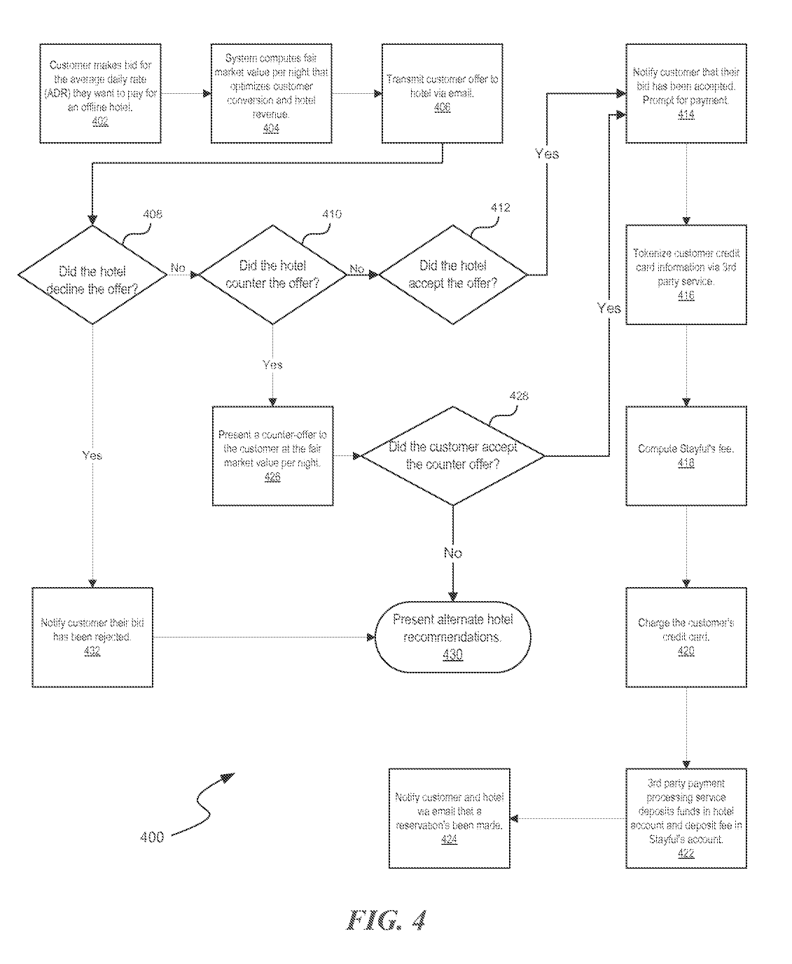

FIG. 4 illustrates an example flow chart of a process that can be implemented by the host server of FIG. 1 for bidding a merchandise item with a non-contracted merchant (e.g., an “offline hotel”). Continuing with the above example, assume that the customer has already chosen a hotel in which the customer is interested, and that the customer has already seen a recommended bid from the host server 100 as well as the lowest available rate for that hotel in the marketplace at the time the customer performs the search.

However, now assume that the customer wishes to engage in a negotiating process on an offline hotel (i.e., from a non-contracted hotel merchant) by entering a bidding offer. In accordance with some embodiments, when a customer makes a bid for an instant hotel, the host server 100 performs the process 400 to facilitate the bidding.

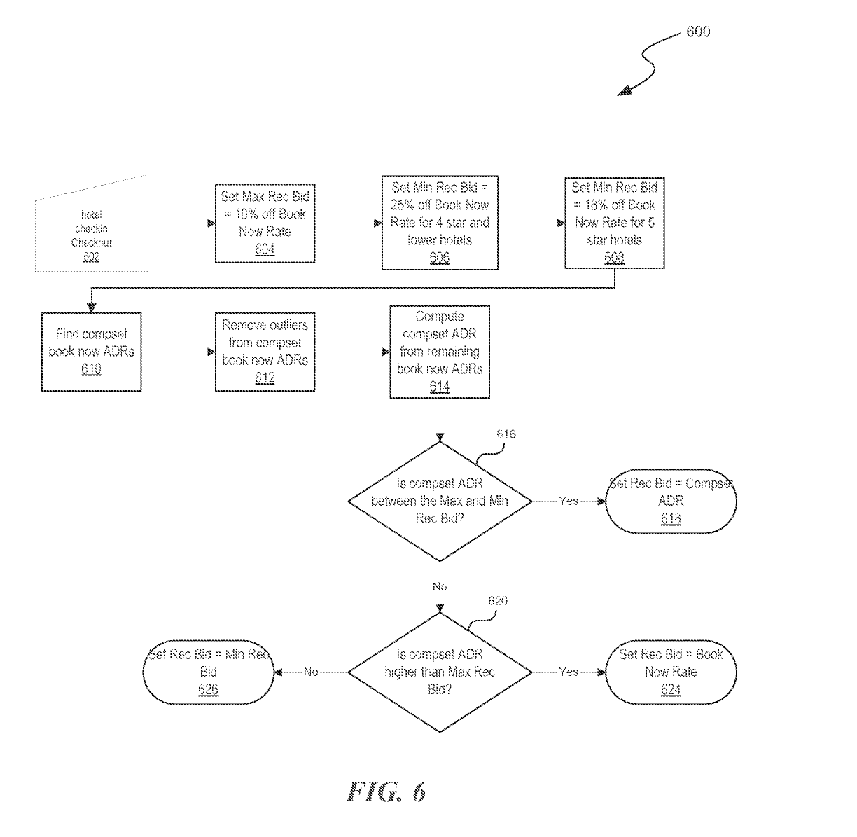

More specifically, after the consumer has seen the lowest rate for that hotel in the marketplace, and after the host server 100 has presented a recommended bid, when the consumer decides (402) what he or she wants to bid, the electronic marketplace platform can facilitate the negotiation by transmitting the customer's bid offer to the hotel (e.g., via an email) so then the (non-contracted) hotel merchant can choose whether to accept/decline/counter the offer. When the customer makes (402) a bid, the host server 100 calculates (404) a fair market value per night for the hotel that the customer is bidding on, which is similar to Step 304. Exemplary calculation and determination processes for Step 404 are discussed in more detail below with respect to FIG. 6. In some embodiments, when communicating the customer's bid to the hotel merchant, the host server 100 also includes the calculated fair market value per night in the communication for the hotel merchant's consideration. Additionally or alternatively, the host server 100 may suggest the fair market value as a counter offer if the merchant declines the offer. As a variation, the host server 100 only suggests a counter offer value when the customer's bid is below but within a predetermined percentage (e.g., 20%) of the calculated fair market value. After the bid offer is communicated to the hotel merchant, the hotel merchant reviews the bid and communicates (408, 410, and 412) to the host server 100 whether to the merchant wishes to accept, counter, or decline the offer (e.g., by engaging different links in the email for acceptance/refusal/counter-offer).

If the merchant accepts (412) the offer, then the host server 100 notifies (414) the customer that the bid has been accepted, and the host server 100 prompts (414) the customer for payment. Similar to Steps 310-318, some embodiments of the host server 100 tokenize (416) the customer credit card information (e.g., after receiving it from Step 414) via a third-party service (e.g., encryption and/or validation services). Optionally, the host server 100 can compute (318) a suitable fee for providing its services, and the host server 100 can connect to one or more payment processing service providers (e.g., via the network 106) to charge (420) the customer's credit card. Then, in some embodiments, the third-party payment processing service provider deposits (422) funds into the hotel merchant's financial account (and deposits suitable fee in a financial account of the provider of the host server 100). Thereafter, the host server 100 notifies (424) the customer and the hotel (e.g., via email) that a reservation has been made.

If the merchant chooses to counter (410) the offer, then the host server 100 presents (426) a counter offer (e.g., via the user interface 104) to the customer. Although not shown in the process 400 for simplicity, one or more embodiments of the host server 100 can receive the counter offer's amount from the merchant; additionally or alternatively, the merchant can choose (e.g., either by default or through configuration in a profile of the merchant) to instruct the host server 100 to counter the offer without specifying a counter offer amount, and the host server 100 can automatically determine the counter offer value (e.g., by adopting the fair market price).

Next, the host server 100 receives (428) a decision from the customer whether the customer accepts the counter offer. If the customer accepts the counter offer, then the host server 100 notifies (414) the customer that the transaction has been accepted and the host server 100 proceeds with the payment steps 416-424. If, however, the customer does not accept the counter offer, then the host server 100 presents (430) alternative hotel recommendations based on those criteria previously entered by the customer.

Referring back to Step 408, if the bid amount entered from the customer is declined by the hotel merchant and without countering the bid, then the host server 100 notifies (432) the customer that the bid has been rejected, and the host server 100 proceeds to Step 430 for alternative hotel recommendations.

According to some embodiments, the host server 100 can (e.g., in the email communicated to the non-contracted hotel merchant) invite the offline hotels to sign up for the instant hotel services (e.g., as described in FIG. 3). In some examples, when a non-contracted hotel merchant accepts the bid (e.g., through engaging the aforementioned link in the email), the non-contracted hotel merchant can be directed to a webpage (e.g., hosted by the host server 100) in which the merchant can sign up and become a contracted hotel merchant. The sign up process can be an automated process implemented in the host server 100.

FIG. 5 illustrates an example flow chart of a method for determining the recommended bid (e.g., Step 304) in the process 300 of FIG. 3. Similar to above, assume the customer has already entered (502) the travel criteria (e.g., travel dates, destination, etc.) and has chosen a hotel in which the customer is interested.

In order to generate the recommended bid (i.e., the “first bid” or the “default bid” when the customer selects the bidding function) for instant hotels, the host server 100 first dynamically generates (504) a competitive set that matches that hotel. The competitive set can include comparable hotel listings that are gathered and stored in the repository 124. What can be considered as comparable can be based on, for example, whether the characteristics of listing (e.g., price, location, review, star, etc.) fall within ±2σ (i.e., standard deviation) of a normal distribution curve. In another example, a competitive set contains all hotels that are of the same star category and within 10-mile radius of the targeted hotel. In variation, the same zip code or other suitable neighborhood designations may be used instead of or in addition to the distance range.

After generating the competitive set, the host server 100 removes (506) any outlier (or exception case) that may be in the competitive set. For example, if the competitive set is made up of hotels that are all three-star, all within a certain neighborhood, all within a certain guest rating, and there exists one hotel that is priced significantly higher (e.g., exceeding 50%) than all the rest of the hotels, which may be signaling that an unknown, idiosyncratic factor is affecting the price. The outlier is removed from the competitive set for purposes of recommended bid price determination. Similarly, if a hotel is priced significantly below the rest of the market (e.g., the rest of the competitive set), then the host server 100 removes that outlier as well. Note that this outlier removal step can function as a safeguard against a scenario where some factor is not captured or sufficiently characterized in the selection of the competitive set, thereby creating an outlier.

After removal of the outlier(s), the host server 100 computes (508) an average daily rate (“ADR”) for the remaining listings in the competitive set. In accordance with one or more embodiments, in order to self-check the accuracy of the fair market price (e.g., against situations where the price distribution in the competitive set represents an abnormal curve), the host server 100 further computes (510, 512) an ADR for both a lowest open discount tier and a highest open discount tier in the competitive set.

Specifically, a lowest open discount tier is a selected number of hotels whose listing or booking prices, after having discounts and other applicable promotions applied for the specified date rage, are in the lower end in the competitive set. Similarly, a highest open discount tier is a selected number of hotels whose listing or booking prices, after having discounts and other applicable promotions applied for the specified date rage, are in the higher end in the competitive set. The number of hotels in a tier can but need not be fixed; in some embodiments, a tier can have a fixed number of hotels, and in other embodiments, a tier can have a variable number of hotels that meet the definition of “lowest open discount tier” or “highest open discount tier.”

In one example, the lowest open discount tier can include those hotels (in the competitive set) whose listing prices are at the bottom 10% of the entire competitive set. In another example, the lowest open discount tier can include the 5 hotels with the lowest listing prices in the competitive set. Similarly, in one example, the highest open discount tier can include those hotels (in the competitive set) whose listing prices are at the top 10% of the entire competitive set. In another example, the highest open discount tier can include the 5 hotels with the highest listing prices in the competitive set.

The lowest and highest open discount tiers can be used by the host server 100 as a safeguard mechanism against situations where the price distribution in the competitive set represents an abnormal curve. For one example, it is recognized in the present disclosure that, when the demand for the hotels becomes very high for certain locations in certain time periods (e.g., early December in New York City, which is typically referred to as the December shopping weekend), the computation of ADR and the generation of recommended bids based upon the competitive set may insufficiently represent the supply and demand dynamics, and in particular, when the price fairly indicative of the demand is actually higher than what the average ADR is (i.e., when the hotels in the competitive set are actually underpricing themselves). With this safeguard mechanism, the electronic marketplace platform can identify when the hotels are underpricing/overpricing (and in particular, underpricing) themselves and increase the accuracy of the fair market value. If the fair market value cannot be accurately determined, then the host server 100 can elect not to show a recommended bid, suggesting to the consumer what the hotels are quoting are already the right rate to pay given the location and the specific time of the year.

After calculating the ADRs for the lowest and highest open discount tiers, the host server 100 determines (514) whether the competitive set's ADR falls between the ADRs for the lowest and highest discount tiers. If the computed ADR for the competitive set does fall within the ADRs of the open discount tiers, then the host server 100 sets (516) the computed ADR for the competitive set as the recommended bid.

Conversely, if the computed ADR for the competitive set does not fall within the ADRs of the open discount tiers, then the host server 100 determines (518) whether the ADR for the competitive set is lower than the ADR for the lowest discount tier. If the ADR for the competitive set is lower than the ADR for the lowest discount tier, then the host server 100 determines (520) whether there are multiple discount tiers.

If there are multiple discount tiers, then the host server 100 sets (522) the recommend bid as the mid-point between the highest and lowest open discount tiers' ADRs. If there are not multiple discount tiers, then the host server 100 sets (524) the recommend bid as the open discount tier's ADR.

Referring back to Step 518, if the ADR for the competitive set is not lower than the ADR for the lowest discount tier, then the host server 100 can reduce the competitive set further by filtering out (526) hotels with an additional and/or alternative rating (e.g., via another third-party hotel rating service provider such as TripAdvisor™). Thereafter, the host server 100 recomputes (528) an ADR for the remaining listings in the new competitive set, and performs the safeguard self-check again.

Subsequently, the host server 100 determines (530) whether the new competitive set's ADR falls between a book-now ADR and the ADR of the lowest discount tier. If the computed ADR for the new competitive set does fall within the book-now ADR and the lowest open discount tier's ADR, then the host server 100 sets (532) the recommended bid as the computed ADR for the new competitive set.

Conversely, if the computed ADR for the competitive set does not fall within the book-now ADR and the ADR of the lowest discount tier, then optionally the host server 100 can reduce the competitive set further by filtering out (534) hotels based on other merchant or merchandise related factors (e.g. filtering out the hotels that are affiliated to certain business chains, thereby favoring an independent hotel). In an alternative implementation, chain hotels can be favored over independent hotels. Thereafter, the host server 100 recomputes (536) the ADR for the remaining listings in the new competitive set, and performs the safeguard self-check again.

Thereafter, the host server 100 determines (538) whether the new competitive set's ADR falls between a book-now ADR and the ADR of the lowest discount tier. If the computed ADR for the new competitive set does fall within the book-now ADR and the lowest open discount tier's ADR, then the host server 100 sets (540) the recommended bid as the computed ADR for the new competitive set.

Conversely, if the computed ADR for the competitive set still does not fall within the book-now ADR and the ADR of the lowest discount tier, then the host server 100 determines (542) whether there are multiple discount tiers in the new competitive set. If there are multiple discount tiers, then the host server 100 sets (550) the recommend bid as the mid-point between the highest and lowest open discount tiers' ADRs.

If there are not multiple discount tiers, then the host server 100 determines (544) whether 10%-off-only discount tier is open. If the 10%-off-only discount tier is open, then the host server 100 sets (546) the recommended bid as 10% off of the book now rate for the hotel. If the 10%-off-only discount tier is not open, then the host server 100 sets (548) the recommend bid as the mid-point between the book now rate and the open discount tier's ADR.

FIG. 6 illustrates an example flow chart of a method for determining the recommended bid (e.g., Step 404) in the process 400 of FIG. 4. Assume the customer has already entered (602) the travel criteria (e.g., travel dates, destination, etc.) and has chosen a hotel in which the customer is interested.

First, the host server 100 sets (604) a maximum recommended bid for the hotel room. The maximum recommended bid is equal to a certain percentage (e.g., 10%) off the lowest book-now rate available for that hotel at the time the search is performed. As mentioned before, the host server 100 can employ a number of web crawlers to gather what the hotel is quoting (e.g., via its website). The gathered data can be stored in the repository 124.

Similarly, the host server 100 sets (606, 608) a minimum recommended bid for the hotel room. The minimum recommended bid is equal to a certain percentage (e.g., 25%) off for hotels that are four stars or lower, and is equal to another percentage (e.g., 18%) off of the lowest rate in the market for hotels that are five stars (assuming a star scale of 1 to 5 is used). Note that, although the present embodiments can be deployed with different percentage numbers, in a preferred example, percentages of 10, 25 and 18, are adopted for maximum recommended bid, minimum recommended bid for hotels of 4-star or lower, and minimum recommended bid for hotels of 5-star, respectively. These numbers are based on long term observation of market rate information.

Thereafter, similar to Step 504, the host server 100 dynamically generates (610) a competitive set that matches that hotel. The competitive set can include comparable hotel listings that are gathered and stored in the repository 124. After generating the competitive set, the host server 100 removes (612) any outlier (or exception case) that may be in the competitive set, similar to Step 506. For example, if the competitive set is made up of hotels that are all three-star, all within a certain neighborhood, all within a certain guest rating, and there exists one hotel that is priced significantly higher (e.g., exceeding 50%) than all the rest of the hotels, which may be signaling that an unknown, idiosyncratic factor is affecting the price. The outlier is removed from the competitive set for purposes of recommended bid price determination. Similarly, if a hotel is priced significantly below the rest of the market (e.g., the rest of the competitive set), then the host server 100 removes that outlier as well. As mentioned above, this outlier removal step can function as a safeguard against a scenario where some factor is not captured or sufficiently characterized in the selection of the competitive set, thereby creating an outlier. After removal of the outlier(s), the host server 100 computes (614) an average daily rate (“ADR”) for the remaining listings in the competitive set, similar to Step 508.

After calculating the ADR for the competitive set, the host server 100 determines (616) whether the competitive set's ADR falls between the maximum and the minimum recommended bids. If the computed ADR for the competitive set does fall within the maximum and the minimum recommended bids determined for the specified hotel and date rage, then the host server 100 sets (618) the recommended bid as the computed ADR for the competitive set.

However, if the computed ADR for the competitive set does not fall within the maximum and the minimum recommended bids determined for the specified hotel and date rage, then the host server 100 determines (620) whether the ADR for the competitive set is higher than the maximum recommended bid. If the ADR for the competitive set is higher than recommended bid, then the host server 100 sets (624) the recommended bid as the book now rate. On the other hand, if the ADR for the competitive set is not higher than recommended bid, then the host server 100 sets (626) the recommended bid as the minimum recommended bid.

In this way, process 600 enables a consumer to make a bid on a hotel that may not be contracted, and incentivizes the non-contracted hotel merchant, through the bid, to join the group of marketplace platform's contracted merchants. With the technique disclosed here, the electronic marketplace platform is particular advantageous over traditional e-commerce platform for promoting the sales of perishable inventory because, among other benefits, the platform introduced here creates a more responsive and more engaging user experience. In particular, by providing the customers both the ability to choose their interested hotels and the ability to facilitate a negotiation with that particular hotel and get prompt results, the electronic marketplace platform introduced here provides a customized system that facilitates the end user to negotiate one by one with a hotel of their own choice, thereby bringing together the buyer and seller (and especially when there is perishable inventory) and facilitating a voluntary exchange at the price determined in that negotiation.

FIG. 7 shows a diagrammatic representation of a machine in the example form of a computer system within which a set of instructions, for causing the machine to perform any one or more of the methodologies discussed herein, may be executed.

The machine may operate as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be implemented on the server side or the client side and may be a personal computer (PC), a tablet PC, a laptop computer, a set-top box (STB), a personal digital assistant (PDA), a cellular telephone, a smart phone, an Internet-capable appliance, a network router, switch or bridge, a game console, a (hand-held) gaming device, a music player, or any suitable machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine to mediate data in a network with an entity that is external to the machine, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

As used herein, a “module,” “a manager,” an “interface,” a “platform,” or an “engine” includes a general purpose, dedicated or shared processor and, typically, firmware or software modules that are executed by the processor. Depending upon implementation-specific or other considerations, the module, manager, interface, platform, or engine can be centralized or its functionality distributed. The module, manager, interface, platform, or engine can include general or special purpose hardware, firmware, or software embodied in a computer-readable (storage) medium for execution by the processor. As used herein, a computer-readable medium or computer-readable storage medium is intended to include all media that are statutory (e.g., in the United States, under 35 U.S.C. §101), and to specifically exclude all media that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112(f), other aspects may likewise be embodied as a means-plus-function claim, or in other forms, such as being embodied in a computer-readable medium. (Any claims intended to be treated under 35 U.S.C. §112(f) will begin with the words “means for”.) Accordingly, the applicant reserves the right to add additional claims after filing the application to pursue such additional claim forms for other aspects of the disclosure.

What is claimed is:

1. A system that implements an auto-negotiation protocol between a customer and a contracted merchant, the system comprising:
a data receiver coupled to a network to receive a plurality of shopping parameters from a user;
a plurality of crawlers, the crawlers employing a plurality of proxy addresses to obtain data regarding expiring inventory of the merchant, the expiring inventory having an expiration date within a predetermined amount of time;
a database for storing the data regarding the expiring inventory; and
a processor coupled to a memory storing a plurality of instructions that, upon execution by the processor, cause the system to:
generate a recommended bid for items in the expiring inventory of the merchant based on analyzing, by the processor, a statistical distribution of expiring inventory in market, the expiring inventory in market including the expiring inventory of the merchant and expiring inventory from other merchants;
prompt the user, via a user interface, to enter the shopping parameters;
determine that one or more items from the data regarding the expiring inventory of the merchant match the shopping parameters;
present, via the user interface, the one or more items to the user for selection, wherein the presentation of the one or more items include an option to enter an auto-negotiation process for a respective item in the one or more items;
upon detecting the user's selection of the option to enter the auto-negotiation process for the respective item, prompt the user, via the user interface, to enter a customer offer;
on behalf of the merchant, automatically determine whether to accept, reject, or to counter the customer offer by a counter-offer based on a predetermined set of rules, wherein the counter-offer is set as the recommended bid for the respective item; and
on behalf of the merchant, accept a transaction for the respective item when the customer accepts the counter-offer.

2. The system of claim 1, wherein the system is further caused to:
present an alternate item based on the customer's shopping parameter and the customer offer when the customer does not accept the counter-offer.

3. The system of claim 1, wherein the set of rules include a rate range on which the automatic determination of whether to accept the consumer offer is based.

4. The system of claim 1, wherein the set of rules include presenting the counter-offer when the customer offer is within a predetermined percentage of the recommended bid for the respective item.

5. The system of claim 1, wherein the set of rules include rejecting the customer offer when the customer offer is not within a predetermined percentage of the recommended bid for the respective item.

6. The system of claim 1, wherein the system is further caused to update the data regarding the expiring inventory periodically.

7. The system of claim 1, wherein the system is further caused to:
notify, via the user interface, the user of whether the customer offer has been accepted, rejected, or is eligible for the counter-offer;
present, via the user interface, the counter-offer to the user; or
present, via the user interface, an alternative merchandise to the user.

8. The system of claim 1, wherein the system is further caused to accept the customer offer when the customer offer is higher than the recommended bid.

9. The system of claim 1, wherein the system is further caused to reject the customer offer when the customer offer is lower than the recommended bid.

10. The system of claim 9, wherein the system is further caused to offer the counter-offer when the customer offer is lower than the recommended bid but higher than a predetermined percentage of the recommended bid.

11. The system of claim 1, wherein the system is further caused to generate the recommended bid by steps comprising:
generating a competitive set from the expiring inventory in market for the respective item;
computing an average daily rate (ADR) of the competitive set;
computing an ADR of a lowest tier and an ADR of a highest tier from the competitive set, wherein the lowest tier includes a select number of items with asking prices that are in a lower end of the competitive set, and wherein the highest tier includes a select number of items with asking prices that are in a higher end of the competitive set; and
generating the recommended bid based on the ADR of the competitive set, the ADR of the lowest tier, and the ADR of the highest tier.

12. The system of claim 11, wherein the system is further caused to adjust the competitive set by steps comprising:
finding outliers within the competitive set, wherein the outliers include items with asking prices that deviate, to a predetermined degree, from a statistical distribution of prices in the competitive set; and
excluding the outliers from the competitive set.

13. The system of claim 11, wherein the system is further caused to generate the recommended bid by setting the recommended bid as the ADR of the competitive set when the ADR of the competitive set is between the ADR of the lowest tier and the ADR of the highest tier.

14. The system of claim 11, wherein the system is further caused to generate the recommended bid by setting the recommended bid as a midpoint between the ADR of the lowest tier and the ADR of the highest tier when the ADR of the competitive set is lower than the ADR of the lowest tier.

15. The system of claim 11, wherein the system is further caused to generate the recommended bid by setting the recommended bid as the ADR of the lowest tier when the ADR of the competitive set is lower than the ADR of the lowest tier.

16. The system of claim 11, wherein the system is further caused to generate the recommended bid by:
adjusting the recommended set using one or more filters on the competitive set, wherein the filters are based on a plurality of quality parameters.

17. The system of claim 16, wherein the system is further caused to:
set the recommended bid as the ADR of the competitive set.

18. The system of claim 16, wherein the system is further caused to:
set the recommended bid as a midpoint between the highest tier ADR and the lowest tier ADR.

19. The system of claim 16, wherein the system is further caused to:
set the recommended bid as a predetermined percentage of an available price for the respective item.

20. A system that facilitates and mimics negotiation between a customer and a non-contracted merchant, the system comprising:
a data collector coupled to a network to receive a plurality of shopping parameters from a user, wherein the shopping parameters include a customer offer on price, a targeted merchandise, and a plurality of merchandise criteria;
a plurality of crawlers, the crawlers employing a plurality of proxy addresses to obtain information regarding an expiring inventory of the merchant, the expiring inventory having an expiration date within a predetermined amount of time;
a database for storing the information regarding the expiring inventory; and
a processor coupled to a memory storing a plurality of instructions that, upon execution by the processor, configure the processor to:
gather relevant data, wherein a relevancy of the relevant data is evaluated based on the shopping parameters;
generate a recommended bid by performing an analysis of a statistical distribution of the relevant data;
on behalf of the user, present the customer offer to the merchant;
on behalf of the user, present the recommended bid as a counter-offer to the merchant when the merchant declines the customer offer; and
on behalf of the customer, accept the transaction, when the merchant accepts the counter-offer.

21. The system of claim 20, wherein the database and the relevant data in the processor are updated upon receiving the shopping parameters.

22. The system of claim 20, wherein the system further comprises a user interface, wherein the user interface is configured to:
present the recommended bid as the counter-offer to the merchant when the merchant declines the customer offer;
present an alternative merchandise to the user when the merchant declines the customer offer and the counter-offer; and
notify the user of an acceptance or a rejection of the customer offer or the counter-offer.

23. The system of claim 20, wherein the processor is further configured to generate the recommended bid by:
generating a competitive set, wherein the competitive set comprises the relevant data;
computing average daily rate (ADR) of the competitive set;
computing a maximum recommended bid and a minimum recommended bid, wherein the maximum recommended bid is a first percentage of the merchant's asking price for the targeted merchandise, the minimum recommended bid is a second percentage of the merchant's asking price for the targeted merchandise, and the first percentage is higher than the second percentage; and
generating the recommended bid based on the ADR of the competitive set, the maximum recommended bid, and the minimum recommended bid.

24. The system of claim 23, wherein the processor is further configured to adjust the competitive set by:
finding outliers within the competitive set, wherein the outliers are merchandises with asking prices deviate, to a predetermined degree, from a statistical distribution of prices in the competitive set; and
excluding the outliers from the competitive set.

25. The system of claim 23, wherein the processor is further configured to generate the recommended bid by setting the recommended bid as the ADR of the competitive set when the ADR of the competitive set is between the minimum recommended bid and the maximum recommended bid.

26. The system of claim 23, wherein the processor is further configured to generate the recommended bid by setting the recommended bid as the minimum recommended bid when the ADR of the competitive set is lower than the minimum recommended bid.

27. The system of claim 23, wherein the processor is further configured to generate the recommended bid by setting the recommended bid as the merchant's asking price for the targeted merchandise when the ADR of the competitive set is higher than the maximum recommended bid.

28. The system of claim 23, wherein the first percentage is calculated based on the merchandise criteria or any other quality factors of the targeted merchandise.

29. The system of claim 23, wherein in a hotel business, the first percentage is set as 90%, and the second percentage is set as 82% for a five-star hotel and 75% for a four-star hotel.

30. A system that implements an auto-negotiation protocol between a customer and a merchant, the system comprising:
a data receiver coupled to a network to receive a plurality of shopping parameters from a user, wherein the shopping parameters include a customer offer on price, a targeted merchandise, and a plurality of merchandise criteria;
a plurality of crawlers, the crawlers employing a plurality of proxy addresses to obtain data regarding expiring inventory of the merchant, the expiring inventory having an expiration date within a predetermined amount of time;
a database for storing the data regarding the expiring inventory; and
a processor coupled to a memory storing a plurality of instructions that, upon execution by the processor, cause the system to:
determine whether the merchant is a contracted merchant;
(1) in a first operating mode where the merchant is determined to be a contacted merchant:
generate a recommended bid for items in the expiring inventory of the merchant based on analyzing, by the processor, a statistical distribution of expiring inventory in market, the expiring inventory in market including the expiring inventory of the merchant and expiring inventory from other merchants;
prompt the user, via a user interface, to enter the shopping parameters;
determine that one or more items from the data regarding the expiring inventory of the merchant match the shopping parameters;
present, via the user interface, the one or more items to the user for selection, wherein the presentation of the one or more items includes an option to enter an auto-negotiation process for a respective item in the one or more items;
upon detecting the user's selection of the option to enter the auto-negotiation process for the respective item, prompt the user, via the user interface, to enter a customer offer;
on behalf of the merchant, automatically determine whether to accept, reject, or to counter the customer offer by a counter-offer based on a predetermined set of rules, wherein the counter-offer is set as the recommended bid for the respective item; and
on behalf of the merchant, accept a transaction for the respective item when the customer accepts the counter-offer;
(2) in a second operating mode where the merchant is determined not to be a contacted merchant:
gather relevant data, wherein a relevancy of the relevant data is evaluated based on the shopping parameters;
generate a recommended bid by performing an analysis of a statistical distribution of the relevant data;
on behalf of the user, present the customer offer to the merchant;
on behalf of the user, present the recommended bid as a counter-offer to the merchant when the merchant declines the customer offer; and
on behalf of the customer, accept the transaction, when the merchant accepts the counter-offer.
